(19) United States
(12) Patent Application Publication
(10) Pub. No.: US 2009/0073150 A1
(43) Pub. Date: Mar. 19, 2009

(54) Liquid crystal display panel with image sensing system and image processing system using same

(75) Inventors: Chu-Jung Shih, Miao-Li (TW); Yuan-Pei Lai, Miao-Li (TW); Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/283,830

(22) Filed: Sep. 15, 2008

(30) Foreign Application Priority Data
Sep. 14, 2007 (CN) 200710076997.9

(51) Int. Cl. G06F 3/038; G09G 3/36

(52) U.S. Cl. 345/207; 345/104

(57) ABSTRACT

A liquid crystal display panel (21) includes a display area (210) and an image sensing system (23). The image sensing system is arranged in the display area. The image sensing system is capable of sensing ambient light and converting the ambient light into image signals. The display area is capable of displaying images corresponding to the image signals.

### FIELD OF THE INVENTION

The present invention relates to a liquid crystal display (LCD) panel with an image sensing system, and an image processing system using the LCD panel.

### GENERAL BACKGROUND

With the spread of digital still-image cameras and digital video cameras, the demand for a camera function in cellular telephones, computer monitors, and the like has risen in recent years. At present, charge coupled device (CCD) light sensors and complementary metal-oxide semiconductor (CMOS) light sensors are widely used as imaging devices in various electronic products. An imaging device employed in a computer monitor, such as an LCD monitor, is usually set at a peripheral area of the LCD monitor, such as a top area or a side area. When a person uses the LCD monitor, the person faces a display area of the LCD monitor. However, the imaging device can only shoot the person's image from a top or the side, therefore the quality of the image may be relatively low. In addition, in order for the person to provide a clear and complete shoot, the person may have to turn his or her head to face the imaging device. This may be inconvenient and distracting.

What is needed is to provide an LCD panel and an image processing system that can overcome the above-described deficiencies.

### SUMMARY

In one aspect, a liquid crystal display panel includes a display area and an image sensing system. The image sensing system is arranged in the display area. The image sensing system is capable of sensing ambient light and converting the ambient light into image signals. The display area is capable of displaying images corresponding to the image signals.

Other novel features and advantages will become more apparent from the following detailed description when taken in conjunction with the accompanying drawings.

### BRIEF DESCRIPTION OF THE DRAWINGS

FIG. 1 is a schematic view of an LCD according to a first embodiment of the present invention, the LCD including an LCD panel with an image sensing system.

FIG. 2 is an abbreviated circuit diagram of the image sensing system of the LCD of FIG. 1, the image sensing system including a plurality of light sensors.

FIG. 3 is an circuit diagram of an exemplary CMOS light sensor which is used in the image sensing system of FIG. 2.

FIG. 4 is an block diagram of an image processing system according to an exemplary embodiment of the present invention.

FIG. 5 is an enlarged, side cross-sectional view of part of the LCD panel of FIG. 1.

FIG. 6 is a side cross-sectional view of part of an LCD panel according to a second embodiment of the present invention.

FIG. 7 is a side cross-sectional view of part of an LCD panel according to a third embodiment of the present invention.

### DETAILED DESCRIPTION OF EMBODIMENTS

Reference will now be made to the drawings to describe exemplary embodiments of the present invention in detail.

FIG. 1 is a schematic view of an LCD according to a first embodiment of the present invention. The LCD 20 includes an LCD panel 21, and a frame 22 for supporting the LCD panel 21. The LCD panel 21 includes a display area 210, and an image sensing system 23 set at a center portion of the display area 210.

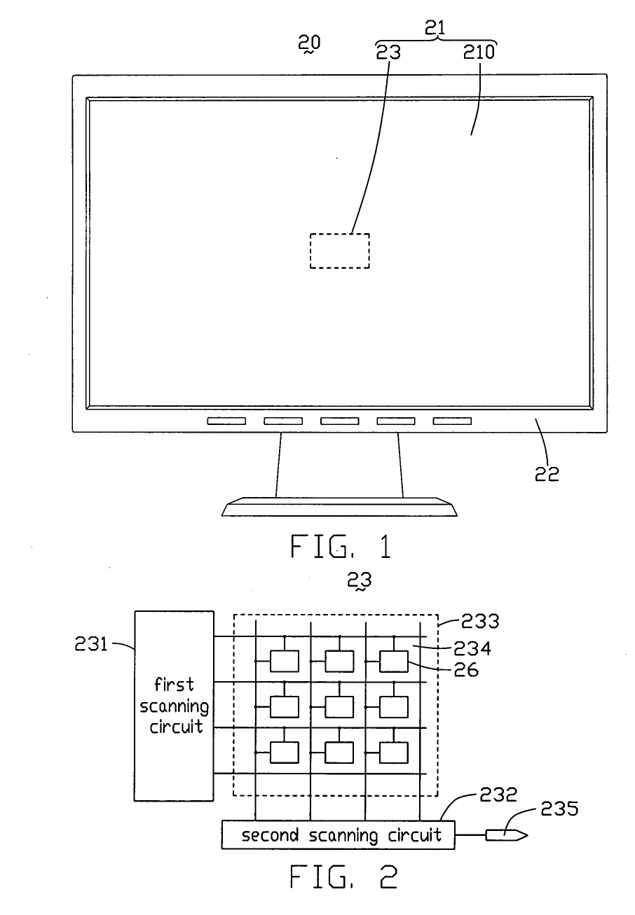

FIG. 2 is an abbreviated circuit diagram of the image sensing system 23. The image sensing system 23 is capable of converting ambient light into electrical image signals. The image sensing system 23 includes a pixel section 233 where a plurality of pixel units 234 are arranged in a matrix, a first scanning circuit 231, a second scanning circuit 232, and an output port 235. Each pixel unit 234 includes a light sensor 26 coupled to the first and second scanning circuits 231, 232 via conductive lines (not labeled). The first scanning circuit 231 includes a vertical scanning shift register (not shown) and a reset control circuit (not shown), for specifying the pixel units 234 in each row of the matrix. The second scanning circuit 232 includes a horizontal scanning circuit (not shown) and a selecting circuit (not shown), for specifying output from the pixel units 234 in each column of the matrix. The output port 235 is coupled to the second scanning circuit 232 for outputting image signals from the second scanning circuit 232.

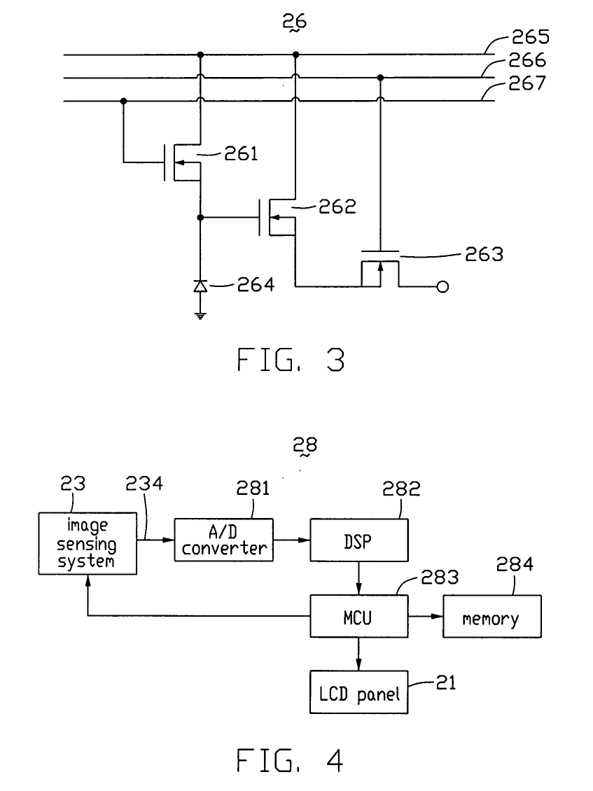

The light sensor 26 in each pixel unit 234 can be a CCD light sensor, a CMOS light sensor, or another suitable kind of light sensor. Taking the CMOS light sensor as an example, a circuit diagram of the CMOS light sensor is shown in FIG. 3. The CMOS light sensor 26 includes a first, a second, and a third transistors 261, 262, 263, a photodiode 264, a reset voltage supply line 265, a selection signal line 266, and a reset signal line 267.

An anode of the photodiode 264 is grounded, and a cathode of the photodiode 264 is electrically coupled to a source electrode of the first transistor 261 and a gate electrode of the second transistor 262. A gate electrode of the first transistor 261 is electrically coupled to the first scanning circuit 231 via the reset signal line 267, and a drain electrode of the first transistor 261 is electrically coupled to the reset voltage supply line 265. A drain electrode of the second transistor 262 is electrically coupled to the reset voltage supply line 265, and a source electrode of the second transistor 262 is electrically coupled a source electrode of the third transistor 263. A gate electrode of the third transistor 263 is electrically coupled to the first scanning circuit 231 via the selection signal line 266, and a drain electrode of the third transistor 263 is electrically coupled to the second scanning circuit 232. Typical operation of the light sensor 26 is as follows:

First, when a reset signal RST is supplied via the reset signal line 267 to the gate electrode of the first transistor 261, the first transistor 261 goes into an ON state with predetermined timing. The reset voltage supply line 265 supplies a reset voltage VR to the drain electrode of the first transistor 261 and the drain electrode of the second transistor 263. The photodiode 264 is charged by the reset voltage VR, and the reset voltage VR is applied to the gate electrode of the second transistor 262 simultaneously. Next, when ambient light strikes the photodiode 264, electric charge is accumulated in the photodiode 264. The amount of the electric charge accumulated is proportional to the intensity of the outside light beams. The electric charge accumulated decreases the potential of the source electrode of the first transistor 261 and the potential of the gate electrode of the second transistor 262, which functions as a source follower amplifier. Thus the voltage at the cathode of the photodiode 264 is amplified by the second transistor 262, and is output from the source electrode of the second transistor 262.

After a predetermined period of time has elapsed, a row selection signal SLCT is input from the row selection signal line 266 to the gate electrode of the third transistor 263, which functions as a row selection element. The third transistor 263 goes into an ON state. Voltage output from the second transistor 262 is output from the drain electrode of the third transistor 263, and transferred to the second scanning circuit 232. The second scanning circuit 232 selects such voltage signal as an image signal, and sends the image signal to a following processing unit, such as a digital signal processing (DSP) unit, and the like.

Referring to FIG. 4, this is a block diagram of an image processing system according to an exemplary embodiment of the present invention. The image processing system 28 includes the LCD panel 21 with the image sensing system 23 described above, an analog-to-digital (A/D) converter 281, a digital signal processor (DSP) 282, a micro controller unit (MCU) 283, and a memory 284.

The image sensing system 23 is configured for sensing ambient light and converting the ambient light into electrical image signals in analog form. The A/D converter 281 receives the analog image signals, and transforms the analog image signals into digital image signals. Then the DSP 282 processes the digital image signals in a next step, for converting the digital image signals into some specified formats that can be recognized by the MCU 383. The MCU 283 controls the image sensing system 23 to function, the memory 284 to store the digital image signals, and the LCD panel 21 to display the corresponding image at the display area 210.

Referring to FIG. 5, this is an enlarged, side cross-sectional view of part of the LCD panel 21. The LCD panel 21 further includes a first substrate 211, a second substrate 214 parallel to the first substrate 211, and a liquid crystal layer 213 sandwiched between the first and second substrates 211, 214. A color filter layer 212 is arranged at an inner surface of the first substrate 211. The color filter layer 214 includes a plurality of red, green, and blue color filter units, 215, 216, 217, for filtering white light into red, green, and blue monochromatic light.

The light sensors 26 of the pixel units 234 are arranged at an inner surface of the color filter 212, adjacent to the liquid crystal layer 213. Each light sensor 26 corresponds to one of the color filter units 215, 216, 217. External light beams are filtered and then strike the light sensor 26. Conductive lines (not shown in FIG. 5) connect the light sensors 26 and the other components. The conductive lines are made of transparent conductive material, such as indium tin oxide (ITO) or indium zinc oxide (IZO).

Furthermore, an outside of each light sensor 26, except the side facing the first substrate 211, is covered by a light shielding layer 27. The light shielding layer 27 is for shielding backlight beams coming from a backlight module (not shown) employed in the LCD 20. Thus the light sensor 26 can only detect light beams from an outside of the LCD 20, without any interference or negative influence from the backlight beams. The light shielding layer 27 can be made of metal, metallic oxide, or resin. Typically, the light shielding layer 27 is made of chromium or (Cr) chromic oxide. A thickness of the light shielding layer can be in a range from 1000 nanometer to 1500 nanometer.

Unlike with conventional LCDs, the LCD 20 includes the image sensing system 23 arranged in the display area 210. This built-in type image sensing system 23 is capable of shooting an image directly in front of the LCD 20. Thus when a person uses the LCD 20, the image sensing system 23 can shoot an image of the person from right in front of the person. This frontal-type image has relatively high quality compared to images obtained with conventional LCDs, and can provide much convenience for the person using the LCD 20.

Moreover, the image sensing system 23 is arranged in the display area 210 of the LCD panel 21. There is no need for an additional camera, and the LCD panel 21 and the LCD 20 can be made to be compact and aesthetically pleasing.

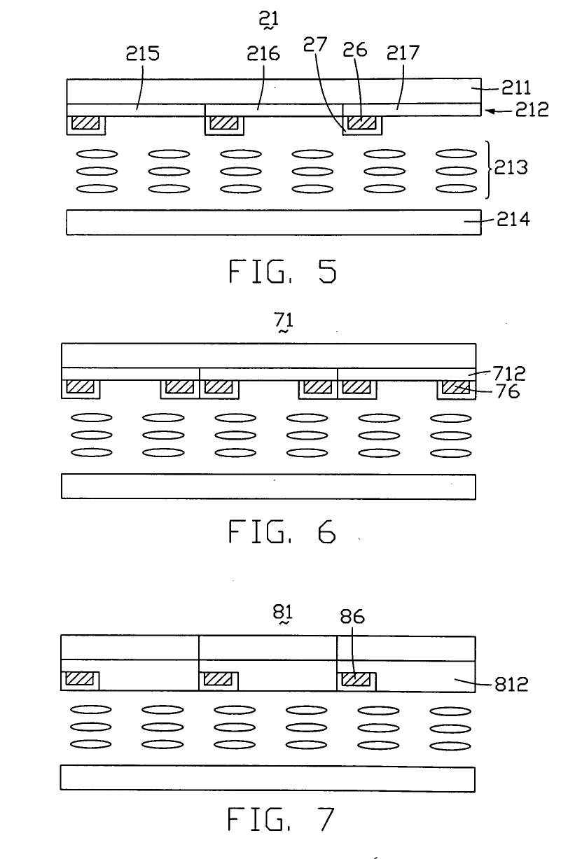

Referring to FIG. 6, this is a side cross-sectional view of part of an LCD panel 71 according to a second embodiment of the present invention. The LCD panel 71 is similar to the LCD panel 21. However, in the LCD panel 71, each of color filter units (not labeled) of a color filter layer 712 corresponds to two separate light sensors 76. Thus in each color filter unit region, the two light sensors 76 cooperatively sense the ambient light. Thus the sensed image is clear and bright, and has a high resolution. That is, the quality of the image is improved.

Referring to FIG. 7, this is a side cross-sectional view of part of an LCD panel 81 according to a third embodiment of the present invention. The LCD panel 81 is similar to the LCD panel 21. However, in the LCD panel 81, light sensors 86 are arranged in a color filter layer 812. Corresponding light shielding layers (not labeled) are also arranged in the color filter layer 812.

It is to be further understood that even though numerous characteristics and advantages of preferred and exemplary embodiments have been set out in the foregoing description, together with details of structures and functions associated with the embodiments, the disclosure is illustrative only; and changes may be made in detail (including in matters of shape, size, and arrangement of parts) within the principles of the invention to the full extent indicated by the broad general meaning of the terms in which the appended claims are expressed.

What is claimed is:

1. A liquid crystal display panel, comprising:
a display area; and
an image sensing system, wherein the image sensing system is arranged in the display area, the image sensing system is capable of sensing ambient light and converting the ambient light into image signals, and the display area is capable of displaying images corresponding to the image signals.

2. The liquid crystal display panel of claim 1, wherein the image sensing system comprises a plurality of pixel units arranged in a matrix, a first scanning circuit, and a second scanning circuit, the pixel units are capable of converting ambient light into electrical signals, and the first and second scanning circuits are respectively coupled to each pixel unit for driving the pixel unit.

3. The liquid crystal display panel of claim 2, wherein the first scanning circuit comprises a vertical scanning shift register and reset control circuit, for specifying the pixel units in each row of the matrix.

4. The liquid crystal display panel of claim 2, wherein the second scanning circuit comprises a horizontal scanning circuit and a selecting circuit, for specifying output from the pixel units in each column of the matrix.

5. The liquid crystal display panel of claim 2, wherein each pixel unit comprises at least one light sensor.

6. The liquid crystal display panel of claim 5, wherein the at least one light sensor is selected from the group consisting of a charge coupled device light sensor and a complementary metal-oxide semiconductor light sensor.

7. The liquid crystal display panel of claim 5, wherein the at least one light sensor comprises a first transistor, a second transistor, a third transistor, a photodiode, a reset voltage supply line, a selection signal line, and a reset signal line, an anode of the photodiode is grounded and a cathode of the photodiode is electrically coupled to a source electrode of the first transistor and a gate electrode of the second transistor, a gate electrode of the first transistor is electrically coupled to the first scanning circuit via the reset signal line, and a drain electrode of the first transistor is electrically coupled to the reset voltage supply line, a drain electrode of the second transistor is electrically coupled to the reset voltage supply line, and a source electrode of the second transistor is electrically coupled a source electrode of the third transistor, a gate electrode of the third transistor is electrically coupled to the first scanning circuit via the selection signal line, and a drain electrode of the third transistor is electrically coupled to the second scanning circuit.

8. The liquid crystal display panel of claim 2, further comprising a first substrate, a second substrate parallel to the first substrate, and a liquid crystal layer sandwiched between the first and second substrates, wherein the image sensing system is arranged between the first substrate and the liquid crystal layer.

9. The liquid crystal display panel of claim 8, wherein the pixel units are arranged between the first substrate and the liquid crystal layer.

10. The liquid crystal display panel of claim 8, further comprising a color filter arranged between the first substrate and the liquid crystal layer, wherein the pixel units are arranged between the first substrate and the color filter.

11. The liquid crystal display panel of claim 8, wherein the color filter comprises a plurality of color filter units, and each of a plurality of the plurality of color filter units corresponds to at least one of the pixel units of the image sensing system.

12. An image processing system, comprising:
a liquid crystal display panel comprising a display area and an image sensing system arranged in the display area, the image sensing system being capable of sensing ambient light and converting the ambient light into electrical image signals;
an analog-to-digital converter configured for converting the electrical image signals into digital image signals;
a digital signal processing unit configured for processing the digital image signals; and
a micro controller unit configured for controlling the image sensing system to function and the liquid crystal display panel to display images corresponding to the image signals at the display area.

13. The image processing system of claim 12, further comprising a memory configured for storing the image signals processed by the micro controller unit.

14. The image processing system of claim 12, wherein the image sensing system comprises a plurality of pixel units arranged in a matrix, a first scanning circuit, and a second scanning circuit, the pixel units are capable of converting the ambient light into the electrical image signals, and the first and second scanning circuits are respectively coupled to each pixel unit for driving the pixel unit.

15. The image processing system of claim 14, wherein the first scanning circuit comprises a vertical scanning shift register and reset control circuit, for specifying the pixel units in each row of the matrix.

16. The image processing system of claim 14, wherein the second scanning circuit comprises a horizontal scanning circuit and a selecting circuit, for specifying output from the pixel units in each column of the matrix.

17. The image processing system of claim 13, wherein each pixel unit comprises at least one light sensor.

18. The image processing system of claim 17, wherein the at least one light sensor is selected from the group consisting of a charge coupled device light sensor and a complementary metal-oxide semiconductor light sensor.

19. The image processing system of claim 17, further comprising a first substrate, a second substrate parallel to the first substrate, and a liquid crystal layer sandwiched between the first and second substrates, wherein the image sensing system is arranged between the first substrate and the liquid crystal layer, and the pixel units are arranged between the first substrate and the liquid crystal layer.

20. The image processing system of claim 19, further comprising a color filter arranged between the first substrate and the image sensing system.
